(19) United States
(12) Patent Application Publication
(10) Pub. No.: US 2010/0064607 A1
(43) Pub. Date: Mar. 18, 2010

(54) Window Frame Spacing Tape and Method for Installing a Window

(76) Inventor: Robert P. Warunek, Clinton Township, MI (US)

Correspondence Address: GREGORY T. ZALECKI, 12900 HALL ROAD, SUITE 400, STERLING HEIGHTS, MI, 48313, US

(21) Appl. No.: 12/210,990

(22) Filed: Sep. 15, 2008

(51) Int. Cl. E06B 1/04

(52) U.S. Cl. 52/213; 52/745.15

(57) ABSTRACT

Window frame spacing tape is used to prevent the latent crushing of a window frame when adjacently installed brick siding expands over time. The tape is comprised of a piece of moisture resistant foam with an adhesive backing covered by a removable nonstick cover. The thickness of the tape is set such that the tape will absorb any expansion of adjacently installed brick without allowing the expansion to deform the window frame. The width of the tape is set such that an edge of the tape forms the base of an appropriately sized caulk receptacle. The tape is placed on the outer periphery of the window frame. Brick siding is then installed such that it abuts the tape.

### BACKGROUND

Virtually every building contains exterior windows. A typical window is secured by a window sash. The sash is framed by a window frame. The window frame is installed into a window opening within the building structure. A nailing fin extends from each side of the window frame. Nails are inserted through the nailing fins in order to secure the window frame to the building structure. Each side of the window frame has a lateral perimeter surface which extends outside the window opening of the structure. Siding material is installed along the face of the building structure and abuts the window frame. A common siding material is comprised of brick and mortar. Some of the brick edges of brick siding are adjacent to the window frame.

Window frame manufacturers typically specify that a gap of approximately ⅜″ should exist between the brick edges and the window frame. This specification is often ignored by bricklayers. They brick in such a way that some of the brick edges directly contact the lateral perimeter surfaces of the window frame. This renders caulking between the brick edges and the window frame to be less effective than caulk which is inserted into a ⅜″ gap between the lateral perimeter surface of the window frame and the brick edges. In other words, without the appropriate gap, air and water leaks around the window frame are more likely. This, however, is not the primary problem caused by laying brick such that the edges of the brick contact the lateral perimeter surface of the window frame. When the brick edges contact the lateral perimeter surface of the window frame, initially there is no problem with window functioning or window aesthetics. The sash is free to move within the window frame, as designed by the window manufacturer. Unfortunately, over the course of time, the brick and mortar tends to expand. It is not unusual for that part of a brick wall contacting the lateral perimeter surface of a window frame at the time of construction to expand over the course of one or two years in such a way that the window frame crushes. As a result of the crushing, the window sash can bind and become inoperable. The crushing also has a negative impact on window aesthetics. This window frame crushing is directly attributable to bricklayers laying bricks such that edges of the brick directly contact the lateral perimeter surface of the window frame, instead of complying with the window manufacturer's specifications requiring the existence of a specified gap between the edges of the brick and the lateral perimeter surface of the window frame. General building settling over the course of time, as well as the drying of wooden structural members, can also cause the bricks to crush the window frame. What is needed is window frame spacing tape and a method for installing a window frame into a building which prevents bricklayers from laying brick such that brick edges abut against the lateral perimeter surface of a window frame.

### SUMMARY

The window frame spacing tape and the method for installing a window frame into a building described herein provide a solution to the problem of brick siding installed too close to a window frame causing the window frame to crush over time.

Window frames typically have a nailing fin extending from each side of the window frame. The plane of the nailing fin is parallel to the plane of the window within the frame. The fins are adapted to be nailed to the building structure when the frame is installed into a window opening within the structure. A portion of the frame extends exteriorly to the structure. Another portion of the frame extends into the interior aspect of the structure. That part of the window frame which is perpendicular to an adjoining nailing fin, which extends outwardly from the nailing fin to the exterior of the building and which is along the external perimeter of the window frame is denoted as the external lateral perimeter surface of the window frame. The term external lateral perimeter surface of the window frame can refer to one side of the window frame, or all sides of the window frame, depending upon the context within which that phrase is used. In the event of any ambiguity, the term external lateral perimeter surface of a window frame is intended to refer to all four sides of a rectangular window frame. Building siding material is typically installed such that the edges of some of that siding material are in close proximity to the external lateral perimeter surface of the window frame. As indicated above, window manufacturers specify that a predetermined first gap exists between the external lateral perimeter surface of the window frame and the edges of adjacent brick.

Window frame spacing tape is comprised of a piece of resilient material and an adhesive backing on the resilient material. Preferably, the resilient material is moisture resistant foam, such as closed cell foam. The term foam, as used herein, means any of various light, porous, semi rigid or spongy materials used for thermal insulation or shock absorption, as in packaging. The resilient material is shaped such that, together with the adhesive backing, it has a thickness substantially the same as the thickness of the predetermined first gap. Preferably, this thickness is ⅜″. The width of the resilient material is such that when an edge is abutted against the nailing fin extending from the window frame and adhered to the external lateral perimeter surface of the window frame it leaves a predetermined second gap between the longitudinal edge of the foam distal to the nailing fin extending from the window frame and a section of a plane parallel to the window within the frame and abutting the external frontal surface of the window frame, wherein said section of the plane extends over the longitudinal edge of the foam, thereby providing a caulk receptacle between the window frame and the siding material of the building into which the window frame is installed. The length of this predetermined second gap is preferably ½″. The longitudinal edge of the foam distal to the nailing fin should be radiused. The additional surface area provided by a radiused edge, as compared to a flat edge, will provide an enhanced caulk base. In other words, there will be increased surface area for the caulk to adhere to. A removable nonstick cover should cover the adhesive backing. This will allow the window frame spacing tape to be handled before installation without the tape adhering to other objects.

In order to use the window frame spacing tape for installing a window frame into a building, a window frame having an external lateral perimeter surface and a nailing fin extending from the frame is selected. Also, a building having a window opening for receiving the window frame is selected. The window frame is installed into the window opening in the traditional manner. An edge of the window frame spacing tape is abutted against the nailing fin extending from the window frame and adhered to the external lateral perimeter surface of the window frame. After this, brick siding is installed onto the building. The plurality of bricks which are adjacent to the external lateral perimeter surface of the window frame are abutted against the resilient material of the window frame spacing tape. When the brick siding expands it will now compress the resilient material, rather than crush the window frame.

### DRAWINGS

These and other features, aspects, and advantages of the present invention will become better understood with regard to the following description, appended claims, and accompanying drawings where:

FIG. 1 is a side elevation view showing a prior art window and frame installed within an opening of a building having brick siding.

FIG. 2 is an enlarged partial side elevation view of the prior art window, frame and building of FIG. 1, showing the window frame crushed into the window sash as a result of the expansion of the brick siding.

FIG. 3 is an exploded perspective view of a window opening within a building structure, a window and frame, window flashing tape, sill spacers and window frame spacing tape, showing the mode of assembly of these components.

FIG. 4 is a partial perspective view showing a window frame attached to a building structure and also showing window frame spacing tape attached to the external lateral perimeter surface of the window frame.

FIG. 5 is a perspective view of window frame spacing tape showing the removable nonstick cover covering the adhesive backing of the window frame spacing tape partially removed.

FIG. 6 is a top view of a window installed into the window opening of a building structure, wherein window frame spacing tape is applied to the external lateral perimeter surface of the window frame and a piece of brick is abutting against the window frame spacing tape.

### DESCRIPTION

The definitions of words and phrases stated above also apply to this section.

Window frame spacing tape 20 is intended to be applied to the external lateral perimeter surfaces 32 of a window frame 30 which has a nailing fin 36 extending from each of its sides. Window frame spacing tape 20 spaces the siding material 52, 54 of a building 44 apart from of the window frame 30 by a predetermined first gap 56.

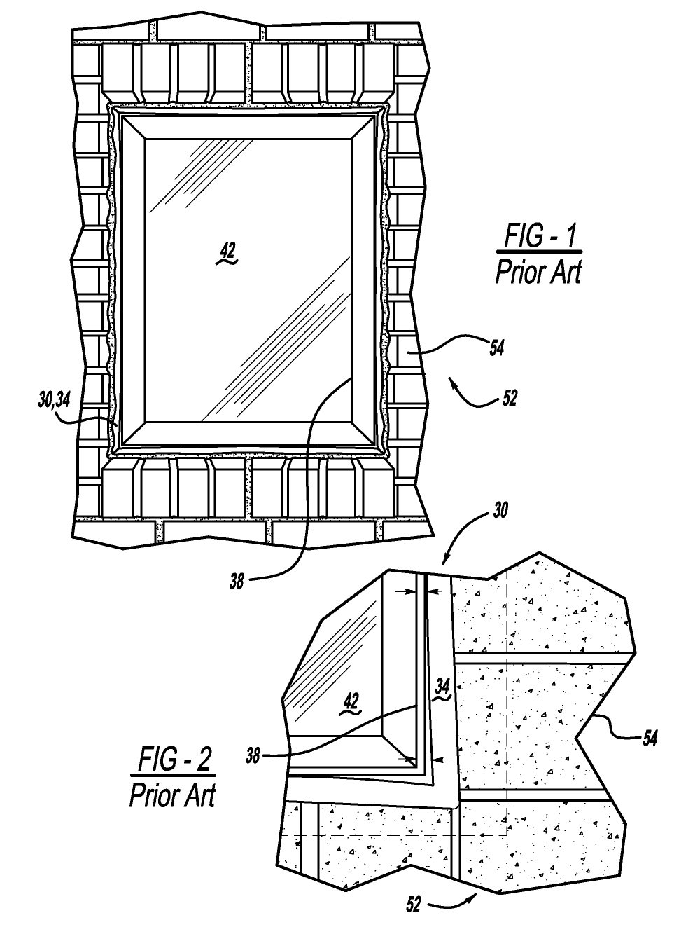

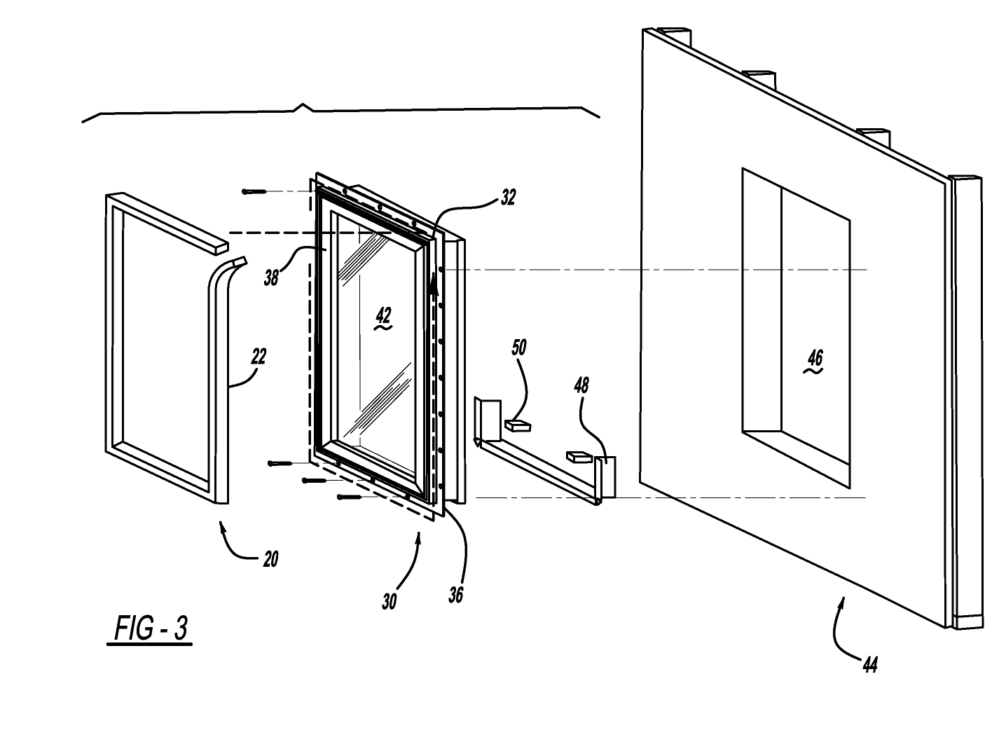

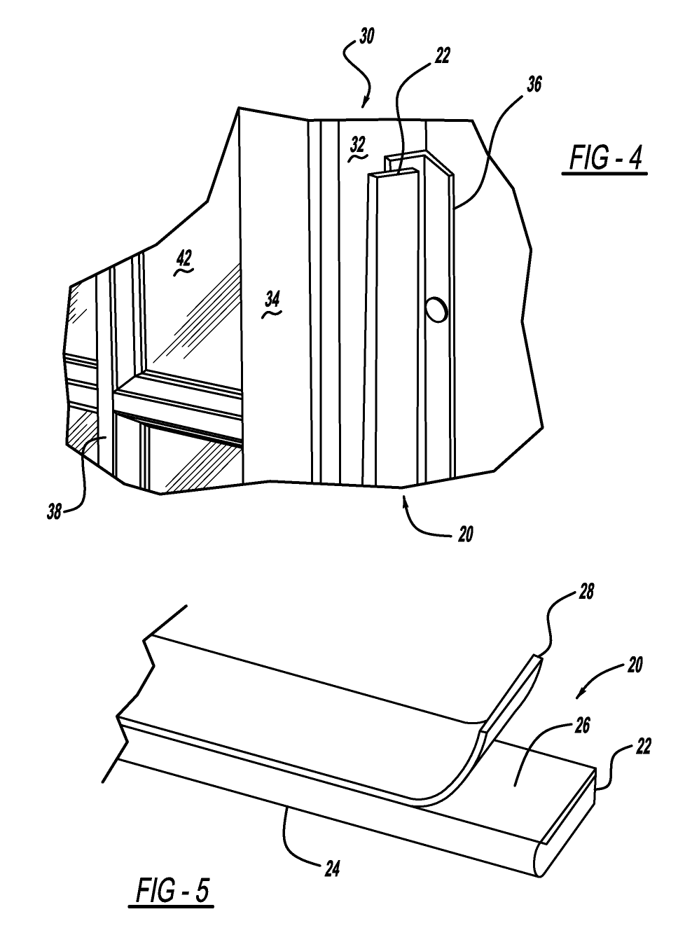

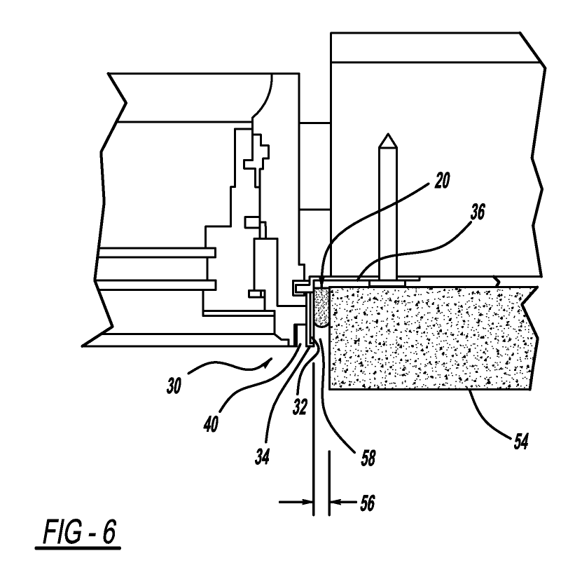

FIGS. 1-6 show window frames 30. A typical window frame 30 is rectangular. The window frame 30 holds a window sash 38. The window sash 38 holds a window 42. Usually, the sash 38 can move within the window frame 30. This allows the window 42 and the window sash 38 to be opened and closed. The window frame 30 has an external frontal surface 34. Typical external frontal surfaces 34 are shown in FIG. 2, FIG. 4 and FIG. 6. The external frontal surfaces 34 are parallel to their respective windows 42. The external frontal surfaces comprise the outermost surface of a window frame 30 when the window frame 30 is installed in the window opening 46 of a building 44, as shown in FIG. 2, FIG. 4 and FIG. 6. Nailing fins 36 extend from each side of a window frame 30, as shown in FIG. 3, FIG. 4 and FIG. 6. The nailing fins 36 have surfaces which are parallel to their respective window 42 surfaces. When a window frame 30 is installed within the window opening 46 of a building 44, a part of the window frame 30 is on the exterior side of the extending nailing fins 36 and another part of the window frame 30 is on the interior side of the extending nailing fins 36, as shown in FIG. 3 and FIG. 6. An extending nailing fin 36 is a nailing fin 36 which extends from an external lateral perimeter surface 32 of a window frame 30 substantially perpendicularly. In other words, if a part of a nailing fin 36 is attached to the external lateral perimeter surface 32 of a window frame 30 such that the surface of that part of the nailing fin is coplanar with and adjacent to the external lateral perimeter surface 32, this part of the nailing fin 36 is not considered to be an extending part of the nailing fin 36. An external lateral perimeter surface 32 exists on the exterior side outer periphery of each side of the window frame 30. The external lateral perimeter surface 32 is perpendicular to the surface of its adjacent nailing fin 36. The external lateral perimeter surfaces 32 of a window frame 30 form the exterior outer periphery of the window frame 30 after it is installed, as shown in FIG. 4 and FIG. 6. Many window frames 30 are fabricated with accessory grooves 40 along and within their external frontal surfaces 34, as shown in FIG. 6. These accessory grooves 40 provide a means for holding window frames 30 together when they are installed adjacent to each other.

The preferred embodiment of window frame spacing tape 20 is comprised of a piece of moisture resistant foam 22, an adhesive backing 26 on the foam 22 and a nonstick cover 28 covering the adhesive backing 26. The foam material 22 is as previously described. The material may also include light, resilient polystyrene plastic, such as that sold under the trade name STYROFOAM. The key feature required for the foam material is that when a piece of the material approximately ⅜″ thick is applied to the external lateral perimeter surface 32 of a window frame, that material may compress to less than 50% of its original thickness when an exterior force is applied to it without causing deformation of the window frame 30. It will also tend to rebound to its original shape when the force is removed. In the preferred embodiment, the foam 22 is moisture resistant. This will prevent the foam 22 from permitting water leakage into the interior aspect of a building on which it is used. Therefore, a closed cell foam 22 is preferred and recommended. The closed cells of the foam 22 each resist water intrusion. For the same reasons, the adhesive backing 26 should also be moisture resistant.

The usual window frame 30 manufacturer's specification for the gap between the external lateral perimeter surface 32 and the edge of adjacent brick siding 52 is ⅜″. This permits the bricks 54 which are adjacent to the external lateral perimeter surfaces 32 of the window frame 30 to expand without crushing the window frame 30. This gap is referred to as the predetermined first gap 56 herein. Thus, the thickness of the foam 22 and the adhesive backing 26 should be the thickness of the predetermined first gap 56. For the typical window frame 30 this is a thickness of approximately ⅜″.

When the window frame spacing tape 20 is applied to the window frame 30 and edge is abutted against an extending nailing fin 36 of the window frame 30 and adhered to the external lateral perimeter surface 32 of the window frame 30. The width of the foam 22 is less than the width of the external lateral perimeter surface 32 of the window frame 30, as shown in FIG. 4 and FIG. 6. Thus, when the window frame 30, the window frame spacing tape 20 and the brick siding 52 are installed there exists a predetermined second gap 58, as shown in FIG. 6. This predetermined second gap 58 is measured from the longitudinal edge 24 of the foam 22 distal to the extending nailing fin 36 to the external frontal surface 34 of the window frame 30. More precisely, the distance is measured from the longitudinal edge 24 of the foam 22 distal to the extending nailing fin 36 to a section of a plane which is parallel to the window 42 within the frame 30. This geometric plane abuts the external frontal surface 34 of the window frame 30. The predetermined second gap 58 depth is measured from the longitudinal edge 24 of the foam 22 distal to the extending nailing fin 36 to a section of the described plane which extends over the distal longitudinal edge 24 of the foam 22. The distal longitudinal edge 24 of the foam is shown in FIG. 5. The term distal means that edge which is furthest away from the nailing fin 36. The predetermined second gap 58 provides a caulk receptacle between the window frame 30 and the siding material 52 of the building 44 into which the window frame 30 is installed. A predetermined second gap 58/caulk receptacle is shown in FIG. 6. A typical manufacturer's specification for caulk depth is ½″. This provides adequate adhesion between the siding material 52, the window frame 30 and the backing within the predetermined second gap 58. Therefore, the depth of the predetermined second gap 58 should be approximately ½″. In prior art installations manufacturers typically suggest that the second gap 58 be filled with ½″ backer rod to provide a base for the caulk. Since backer rod is cylindrical, the caulk base (i.e. the floor upon which the caulks sets) is radiused. A radiused base provides more surface area for caulk adhesion than a flat base. Therefore, in the preferred embodiment of window frame spacing tape 20, the longitudinal edge 24 of the foam distal to its respective extending nailing fin 36 is radiused for the purpose of providing an enhanced caulk base. A recommended radius for a ⅜″ thick piece of foam 22 is one half the thickness— 3/16″. The gap depth should be measured from the crest of the radiused edge 24.

Window frame spacing tape 20 is used as follows. A window frame 30 having an external lateral perimeter surface 32 and a nailing fin 36 extending from the frame 30 (there are four such surfaces 32 and nailing fins 36 on a rectangular window frame 30) is selected. A length of window frame spacing tape 20 is selected which is sufficient to cover all of the external lateral perimeter surfaces 32 of the window frame 30. A building 44 having a window opening 46 for receiving a window frame 30 is selected. See FIG. 3. The window frame 30 is installed into the window opening 46 of the building 44. Typically, the window frame 30 is supported by a pair of sill spacers 50 and flashing tape 48 is used to create a waterproof seal between the window frame 30 and the building 44. The window frame 30 is secured to the building 44 by inserting nails through the nailing fins 36. After the nonstick cover 28 is removed from the adhesive backing 26, the window frame spacing tape 20 is abutted against the extending nailing fins 36 of the window frame 30 and adhered to the window frame 30, as shown in FIG. 4. The window frame spacing tape 20 may also be applied to the external lateral perimeter surfaces 32 of the window frame 30 before the window frame 30 is installed. The window frame spacing tape 20 may be applied by attaching an individual segment of the tape 20 to each of the four external lateral perimeter surfaces 32 of a rectangular window frame 30. It may also be applied as one continuous segment of the tape 20 around all four external lateral perimeter surfaces 32 of a rectangular window frame. Brick siding 52 is then installed onto the building such that a plurality of the bricks 54 comprising the brick siding 52 abut against the foam 22 of the window frame spacing tape 20. FIG. 6 shows one such brick 54 abutting against the foam 22 of window frame spacing tape 20. A correctly dimensioned predetermined first gap 56 and a correctly dimensioned predetermined second gap 58 results, as shown in FIG. 6. Therefore, the installed brick 54 may expand without crushing the window frame 30. Additionally, an appropriately sized caulk receptacle is formed.

Although the invention has been shown and described with reference to certain preferred embodiments and methods, those skilled in the art undoubtedly will find alternative embodiments and methods obvious after reading this disclosure. With this in mind, the following claims are intended to define the scope of protection to be afforded the inventor, and those claims shall be deemed to include equivalent constructions insofar as they do not depart from the spirit and scope of the present invention.

What is claimed is:

1. Window frame spacing tape for application to the external lateral perimeter surface of a window frame having an extending nailing fin and for spacing the siding material of a building apart from the window frame by a predetermined first gap, said window frame spacing tape comprising:
(a) a piece of resilient material; and
(b) an adhesive backing on the resilient material;
(c) wherein the resilient material is shaped such that, together with the adhesive backing, it is has a thickness substantially the same as the thickness of the predetermined first gap.

2. The window frame spacing tape of claim 1, further comprising a removable nonstick cover covering the adhesive backing.

3. The window frame spacing tape of claim 1, wherein the resilient material is moisture resistant foam.

4. The window frame spacing tape of claim 3, wherein the foam is closed cell foam.

5. The window frame spacing tape of claim 1, wherein the resilient material has a width such that when it is adhered to the external lateral perimeter surface of the window frame and abutted against the extending nailing fin of the window frame, a predetermined second gap exists between the longitudinal edge of the foam distal to the extending nailing fin and a section of a plane parallel to the window within the frame and abutting the external frontal surface of the window frame, said section of the plane extending over said longitudinal edge, said second gap providing a caulk receptacle between the window frame and the siding material of a building into which the window frame is installed.

6. The window frame spacing tape of claim 5, wherein the width of the resilient material is sized such that the predetermined second gap will provide a reveal of approximately ½ inch between the longitudinal edge of the foam distal to the extending nailing fin and a section of a plane parallel to the window within the frame and abutting the external frontal surface of the window frame, said section of the plane extending over said longitudinal edge, said second gap providing a caulk receptacle between the window frame and the siding material of a building into which the window frame is installed.

7. The window frame spacing tape of claim 1, wherein said longitudinal edge of the foam distal to the extending nailing fin is radiused for providing a caulk base.

8. The window frame spacing tape of claim 1, further comprising a window frame having an external lateral perimeter surface and a nailing fin extending from said frame, wherein the window frame spacing tape is adhered to the external lateral perimeter surface of the window frame and abutted against the extending nailing fin.

9. The window frame spacing tape of claim 8, further comprising a building having a window opening and brick siding, wherein the window frame is installed into the window opening and some of the bricks comprising the brick siding abut against the resilient material.

10. Window frame spacing tape for application to the external lateral perimeter surface of a window frame having an extending nailing fin and for spacing the siding material of a building apart from the window frame by a predetermined first gap, said window frame spacing tape comprising:
(a) a piece of moisture resistant foam;
(b) an adhesive backing on the foam; and
(c) wherein the moisture resistant foam is shaped
(i) such that, together with the adhesive backing, it is approximately ⅜ inch thick;
(ii) has a width such that when it is adhered to the external lateral perimeter surface of the window frame and abutted against the extending nailing fin of the window frame, a second gap of approximately ½ inch exists between the longitudinal edge of the foam distal to the extending nailing fin and a section of a plane parallel to the window within the frame and abutting the external frontal surface of the window frame, said section of the plane extending over said longitudinal edge, said second gap providing a caulk receptacle between the window frame and the siding material of a building into which the window frame is to be installed; and
(iii) such that said longitudinal edge of the foam distal to the extending nailing fin is radiused for providing a caulk base.

11. The window frame spacing tape of claim 10, further comprising a window frame having an external lateral perimeter surface and a nailing fin extending from said frame, wherein the window frame spacing tape is adhered to the external lateral perimeter surface of the window frame and abutted against the extending nailing fin.

12. The window frame spacing tape of claim 11, further comprising a building having a window opening and brick siding, wherein the window frame is installed into the window opening and some of the bricks comprising the brick siding abut against the resilient material.

13. The window frame spacing tape of claim 10, further comprising a removable nonstick cover covering the adhesive backing;

14. A method for installing a window frame into a building comprising the steps of:
(a) selecting window frame spacing tape for application to the external lateral perimeter surface of a window frame having an extending nailing fin and for spacing the siding material of a building apart from the window frame by a predetermined first gap, said window frame spacing tape comprising:
(i) a piece of resilient material; and
(ii) an adhesive backing on the resilient material;
(iii) wherein the resilient material is shaped such that, together with the adhesive backing, it is has a thickness substantially the same as the thickness of the predetermined first gap;
(b) selecting a window frame having an external lateral perimeter surface and a nailing fin extending from said frame;
(c) selecting a building having a window opening for receiving a window frame;
(d) installing the window frame into the window opening of the building; and
(e) abutting the window frame spacing tape against the extending nailing fin of the window frame and adhering the window frame spacing tape to the external lateral perimeter surface of the window frame.

15. The method for installing a window frame into a building of claim 14, further comprising the step of installing brick siding onto the building such that a plurality of the bricks comprising the brick siding abut against the resilient material of the window frame spacing tape.

16. The method for installing a window frame into a building of claim 14, wherein the resilient material is moisture resistant foam.

17. The method for installing a window frame into a building of claim 16, wherein the foam is closed cell foam.

18. The method for installing a window frame into a building of claim 14, wherein the resilient material has a width such that when it is adhered to the external lateral perimeter surface of the window frame and abutted against the extending nailing fin of the window frame, a predetermined second gap exists between the longitudinal edge of the foam distal to the extending nailing fin and a section of a plane parallel to the window within the frame and abutting the external frontal surface of the window frame, said section of the plane extending over said longitudinal edge, said second gap providing a caulk receptacle between the window frame and the siding material of a building into which the window frame is installed.

19. The method for installing a window frame into a building of claim 18, wherein the width of the resilient material is sized such that the predetermined second gap will provide a reveal of approximately ½ inch between the longitudinal edge of the foam distal to the extending nailing fin and a section of a plane parallel to the window within the frame and abutting the external frontal surface of the window frame, said section of the plane extending over said longitudinal edge, said second gap providing a caulk receptacle between the window frame and the siding material of a building into which the window frame is installed.

20. The method for installing a window frame into a building of claim 14, wherein said longitudinal edge of the foam distal to the extending nailing fin is radiused for providing a caulk base.
